(19) United States
(12) Patent Application Publication
(10) Pub. No.: US 2005/0220456 A1
(43) Pub. Date: Oct. 6, 2005

(54) Signal processing method and optical pickup capable of reducing signal distortion

(76) Inventors: Chia-Hua Chou, Hsintien City (TW); Tse-Hsiang Hsu, Hsinchu (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/046,061

(22) Filed: Jan. 27, 2005

Related U.S. Application Data
(60) Provisional application No. 60/521,085, filed on Feb. 19, 2004.

(51) Int. Cl. H04B 10/00

(52) U.S. Cl. 398/159

(57) ABSTRACT

A signal processing method and an optical pickup are capable of reducing signal distortion. Before being transmitted over a flexible cable to an optical disk drive controller, light detection signals or their arithmetic results are tracked/held in the optical pickup, wherein the desired portions are tracked and the undesired portions are held. By this way, the interference, which is caused from the undesired portions, to the desired portions is mitigated. Therefore, the stability of an optical disk servo control is improved, especially for a high-speed optical disk system.

### BACKGROUND OF THE INVENTION

1. Field of the Invention

The present invention relates to a signal processing method and an optical pickup for reducing signal distortion, and particularly relates to a method and apparatus which reduce the extent of signal distortion resulted from a signal transmission flexible cable.

2. Description of Related Art

With reference to FIG. 1, a conventional optical disk drive (ODD) architecture is composed of an optical pickup unit (12), an ODD controller (14), and a flexible cable (16) coupled between the optical pickup unit (12) and the ODD controller (14). The optical pickup unit (12) comprises a laser diode driver (LDD) (120), a laser diode (LD) (122), a monitor photo detector (123), a splitter (124), an objective lens (126), a photo detector (128) and a signal processing module (130).

The ODD controller (14) includes a servo controller (142) and an analog front-end unit (140) in which a track/hold circuit (144) is provided. A track/hold signal generator (146), which is usually implemented in the servo controller (142), is applied to control the track/hold circuit (144).

When inspecting the optical disk (10), plural wobble tracks with grooves are formed on its surface. It is noted that the tracks are not arranged in the form of concentric circles but like a wave pattern. With reference to FIG. 2, the plural curves (27) on the optical disk (10) stand for the wobble tracks. The photo detector (128) is composed of a main light receiving element (20) and two auxiliary light receiving elements (22)(24). The main light receiving element (20) includes four light detection areas A, B, C and D, where two areas A and D are situated by one side of a virtual track (28) and the other areas B and C are situated by the other side of the virtual track (28). Similarly, the first auxiliary light receiving element (22) with light detection areas E and F is located by one side of the virtual track (28) while the second auxiliary light receiving element (24) with light detection areas G and H is at the other side. Each of the aforementioned light detection areas A-F will produce and transmit an independent signal to a gain buffer (26) thus generating corresponding light detection signals S_{A}, S_{B}, S_{C}, S_{D}, S_{E}, S_{F}, S_{G} and S_{H}. Based on the eight light detection signals, various kinds of signals such as a push pull signal, a tracking error signal, a focusing error signal and a radio frequency signal all can be easily generated accordingly.

Based on the control of the LDD driver (120), the LD (122) can generate a laser beam that irradiates on an optical disk (10) through the splitter (124) and the objective lens (126). The reflected laser beam from the optical disk (10) is then received by the photo detector (128) and converted into plural light detection signals. The light detection signals are processed by the signal processing module (130) to generate one or more electrical signals.

These electrical signals are subsequently transmit to the ODD controller (14) through the flexible cable (16). The analog front-end unit (140) in association with track/hold circuit (144) retrieves desired information from the electrical signals to perform relevant signal processing such as wobble signal recovery. Based on the processing result, control signals required for optical disk operations are produced and provided to the servo controller (142).

For example, during the wobble signal recovery process, the push pull signal S_{PP} is an essential signal and can be generated in accordance with S_{PP}=(S_{A}+S_{D})−(S_{B}+S_{C}). Once the push pull signal S_{PP} has been derived, the wobble signal can then be recovered accordingly, and thus obtaining the physical address of the optical disk (10). The push pull signal S_{PP} can be derived by feasible schemes explained as follows.

1. The light detection signals S_{A}, S_{B}, S_{C} and S_{D} are firstly transmitted to the ODD controller (14) via the flexible cable (16) from the optical pickup unit (12), wherein the light detection signals received by the ODD controller (14) are respectively denoted with S*_{A}, S*_{B}, S*_{C} and S*_{D} hereinafter for distinction. Upon the received light detection signals, the ODD controller (14) performs the operation S_{PP}=(S*_{A}+S*_{D})−(S*_{B}+S*_{C}) to derive the push pull signal S_{PP}.

2. The light detection signals S_{A} and S_{D} are added together by the optical pickup unit (12) to derive a composite signal S_{AD} (S_{AD}=S_{A}+S_{D}). The addition operation is also performed on the other two signals S_{B} and S_{C} to generate another composite signal S_{BC} (S_{BC}=S_{B}+S_{C}). The two composite signals S_{AD} and S_{BC} are subsequently transmitted to the ODD controller (14) via the flexible cable (16). Upon receiving the composite signals, respectively denoted by S*_{AD} and S*_{BC}, the ODD controller (14) directly performs an operation S*_{AD}-S_{*BC} to derive the push pull signal S_{PP}.

When the optical disk drive performs a high-speed recording operation, since the power of the laser beam from the laser diode (122) is varied with data to be written, the output light detection signals of the photo detector (128), the push-pull signal generated based on the light detection signals, the tracking error signal, the focusing error signal and radio frequency signal all accordingly have the similar variation.

With reference to FIG. 3, the light detection signal SA output from the optical pickup unit (12) and the light detection signal S*_{A} received by the ODD controller (14) are respectively illustrated by a broken line and a solid line. Since other light detection signals have the similar waveform as the signal S_{A}, they are accordingly omitted from the drawing. During the pit-forming period, the output laser beam from the laser diode (120) has the stronger power relative to the land-forming period so that the light detection signal has a higher level than that in the land-forming period.

As mentioned above, the output signals of the optical pickup unit (12) are transmitted to the ODD controller (14) via the flexible cable (16) and proceeded with track/hold and subsequent processes. However, for high frequency signal transmission, the flexible cable (16) is unable to provide superior transmission quality. Limited by factors such as poor transmission bandwidth and low slew rate, at the time that the levels of signals are altered, a settling time (32) is required to complete the level change. In other words, part of signals in the land-forming period, (the interested portion) are often interfered with by signals in the pit-forming period (the uninterested portion) and thereby cause an undesired distortion. The settling time is especially relevant to the transmission quality of the flexible cable (16) and the level difference of the signals, but is substantially irrelevant to the running speed of the optical disk. With the increasing of the running speed of the optical disk, the ratio of settling time (32) to the whole land-forming period will significantly increase. In other words, the available noninterference portion (34) during the land-forming period becomes less, which may cause an abnormal operation of the disk driver. Furthermore, although signal wires in the optical pickup unit (12) and the ODD controller (14) may affect the quality of signal transmission, the major course to result in the signal distortion is the flexible cable (16).

If the data recording process remains at low speed, the settling time (32) does not occupy too much land-forming period. Such an interference problem is still tolerable. However, with the increasing of the date recording speed, i.e. both the pit-forming period and the land-forming period are shortened, the extent that the settling time (32) exists in the whole land-forming period will significantly increase. The worst situation is the settling time (32) occupies almost all the land-forming period and there is no available period (34). That is to say, no stabilized light detection signal is able to be sampled, and the optical disk driver may have possible abnormal operation.

With reference to FIG. 4(a), the track formed on an optical disk mainly comprises the pit portions and land portions. FIG. 4(b) illustrates waveforms of signals output from the photo detector (128), wherein the output laser beam from the optical pickup unit (12) has the stronger power during the pit-forming period thus the light detection signal has a higher level than that in the land-forming period. After the light detection signal is transmitted to the ODD controller via the flexible cable (16), its waveform is depicted in FIG. 4(c). At the time that the pit-forming period is altered to the land-forming period, the signal has a descended portion caused by the flexible cable (16) during the land-forming period. For the high speed operation of the disk drive, as shown in FIG. 4(d), the descended portion existing in the signal becomes longer with respect to the land-forming period. In FIGS. 4(b)-4(d), signals surrounded with square broken lines represent the portions to be tracked/held. Obviously, with the increasing of the recording speed, the available portions in the land-forming period are reduced.

Therefore, the invention provides a novel method and apparatus for high speed optical storage device to mitigate or obviate the aforementioned problem.

### SUMMARY OF THE INVENTION

The main objective of the present invention is to provide a signal processing method and an optical pickup for reducing signal distortion, wherein the method and the apparatus are able to maintain high quality of light detection signals even when the optical disk drive performs high-speed data recording whereby the read/write periods of the apparatus are significantly shortened.

To accomplished the objective, the method performs a clamping process on the light detection signals or their composite signals before transmitting to an optical disk drive controller via a flexible cable, whereby the highest level of each of these clamped signals remains below a clamping threshold. By this way, the valid portion of the clamped signal, during the land-forming period, for a follow-up signal process, is increased.

Furthermore, the apparatus in accordance with the present invention comprises:
an optical pickup unit that has:
a laser light source generating a laser beam to irradiate on a track formed on an optical disk;
a photo detector that receives a reflected light from the optical disk and converts the reflected light signal into plural light detection signals; and
a signal processing module in which the light detection signals are processed to generate at least one electrical signal, wherein the signal processing module comprises a track/hold unit that is based on a first track/hold signal to perform a track/hold process over signals input to the track/hold unit;
an optical disk drive (ODD) controller provided to control the optical pickup unit; and
at least one flexible cable coupled between the optical disk drive controller and the optical pickup unit for transmitting signals therebetween;
wherein since the track/hold process is performed prior to the at least one electrical signal being transmitted to the ODD controller, a distortion of the at least one electrical signal caused from the flexible cable is mitigated.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a conventional optical disk driver;

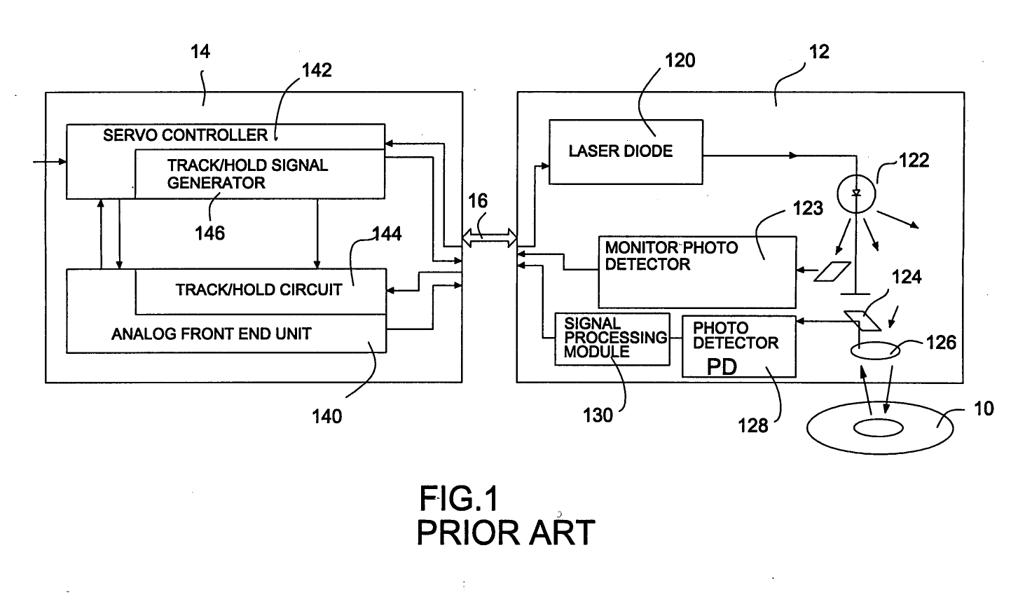

FIG. 2 is an exemplary architecture schematic view of a conventional photo detector;

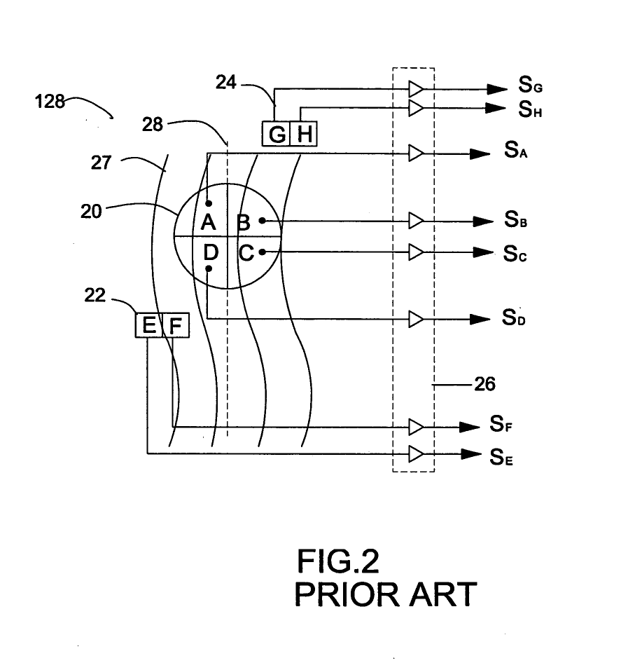

FIG. 3 is an exemplary waveform view showing a light detection signal SA output from an optical pickup unit and a transmitted light detection signal S*_{A} received by an optical disk drive controller in accordance with the conventional data recording process;

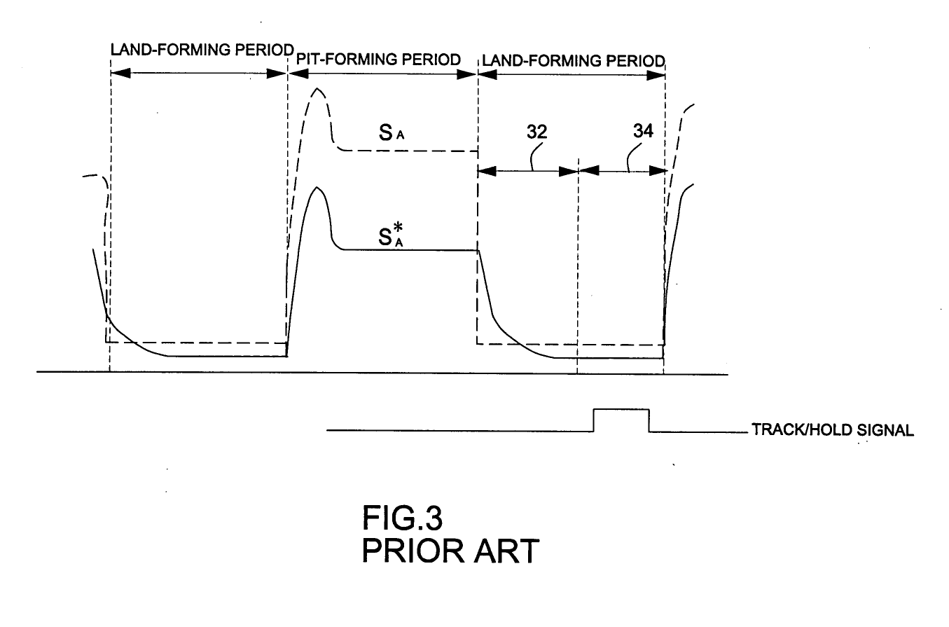

FIGS. 4(a)-4(d) show a track formed on an optical disk as well as the conventional waveforms of the light detection signals detected during data recording;

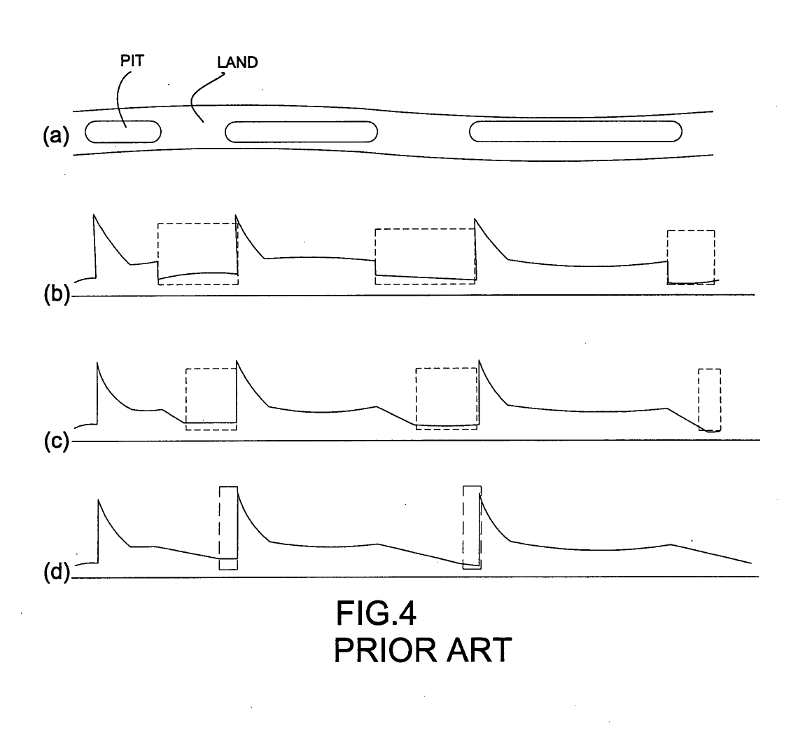

FIG. 5A is a block diagram of an optical disk drive according to an embodiment of the present invention;

FIG. 5B is a block diagram of an optical disk drive according to another embodiment of the present invention;

FIG. 6 is a block diagram of an optical disk drive according to yet another embodiment of the present invention;

FIG. 7(a)-7(d) show an exemplary waveform view showing an EMF signal and a track/hold signal in accordance with the present invention;

FIG. 8 is an exemplary embodiment of a track/hold circuit in accordance with the present invention;

FIG. 9 is a block diagram of a track/hold circuit in accordance with the present invention; and

FIG. 10 shows waveforms of signals in the track/hold circuit of FIG. 9.

### DETAILED DESCRIPTION OF THE PREFERRED EMBODIMENT

In the present invention, a tracking/holding process is performed over light detection signals or their composite signals in advance, before being transmitted to an ODD controller via a flexible cable. Because these light detection signals are not affected by the flexible cable before being transmitted, there are more available portions remaining in these light detection signals.

After the ODD controller receives these tracked/held light detection signals or their composite signals, available portions of the light detection signals accordingly increase to supply more useful information and control signals with superior quality. The foregoing control signals may be a push pull signal, a tracking error signal, a focusing error signal, a radio frequency signal etc. In the embodiments discussed hereinafter, the push pull signal is used as an example and discussed in detail. However, the present invention is also suitable to acquire superior forms of other control signals.

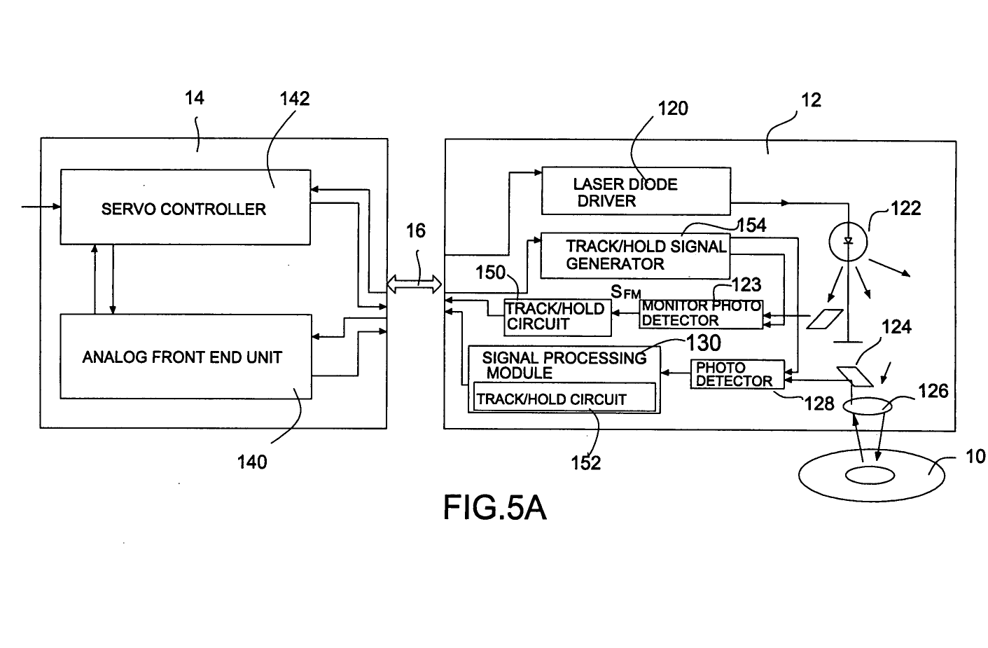

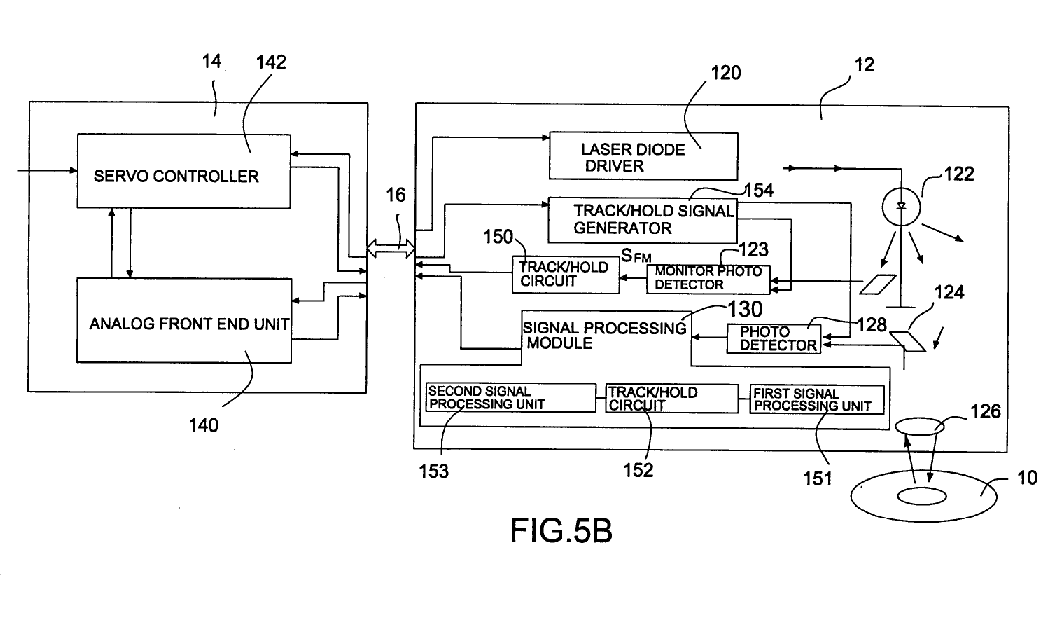

With reference to FIG. 5A, an optical disk drive in accordance with an embodiment of the present invention comprises an optical pickup unit (12) and an optical disk driver (ODD) controller (14) between which a flexible cable (16) is connected. The optical pickup unit (12) mainly has a laser diode driver (120), a laser diode (122), a monitor photo detector (123), a splitter (124), an objective lens (126), a photo detector (128), a signal processing module (130) and a track/hold signal generator (154). The ODD controller (14) includes a servo controller (142) and an analog front-end unit (140).

A track/hold circuit (150) is coupled to the output of the monitor photo detector (123), and a track/hold unit (152) is established in the signal processing module (130). The operation timing of both the track/hold circuit (150) and the track/hold unit (152) is determined by the track/hold signal generator (154).

The track/hold signal generator (154) is an independent circuit, and is able to be implemented in the laser diode driver (120). Moreover, the track/hold circuit (150) is also able to be implemented in the monitor photo detector (123).

Activated by the laser photo driver (120), the laser diode (122) emits a laser beam to irradiate on the optical disk (10). However, a part of the laser beam is received by the monitor photo detector (123) and converted into a light detection signal S_{FM}. The light detection signal S_{FM}, which is used to monitor the output power of the laser beam, will then be subsequently transmitted to the servo controller (142) through the flexible cable (16). When laser beam is reflected from an optical disk (10), the photo detector (128) receives and converts it into plural light detection signals respectively denoted by S_{A}, S_{B}, S_{C}, S_{D}, S_{E}, S_{F}, S_{G} and S_{H}.

The light detection signal S_{FM} output from the monitor light detector (123) is tracked/held by the track/hold circuit (150) to retrieve desired available information contained therein. The retrieved information is then transmitted to the ODD controller (14) through the flexible cable (16). Such a tracking/holding process is also performed over the light detection signals S_{A} to S_{H} or their composite signals by the track/hold unit (152). Through the tracking/holding process performed in advance, available information contained in the light detection signals is ensured to be retrieved before being transmitted to the ODD controller (14). In other words, the extent that the light detection signals interfered with by the flexible cable (16) can be mitigated as much as possible.

Based on the reception of an EFM (eight to fourteen modulation) signal, the track/hold signal generator (154) provides track/hold signals to both the track/hold circuit (150) and the track/hold unit (152).

The signal processing module (130) is able to merely include the track/hold unit (152). For example, if the signal processing module (130) receives the light detection signals S_{A} to S_{D}, the track/hold unit (152) is preferably composed of four independent track/hold circuits to correspond to the four light detection signals S_{A} to S_{D}. These processed signals, as the output signals of the signal processing module (130), are respectively represented by S′_{A}, S′_{B}, S′_{C} and S′_{D} for distinction from the original signals.

With reference to FIG. 5B, the signal processing module (130) further comprises a first signal processing unit (151) coupled between the input of the signal processing module (130) and the track/hold unit (152). Upon the reception of the light detection signals, the first signal processing unit (151) generates calculated composite signals. For instance, based on the received light detection signals S_{A} to S_{D}, the first signal processing unit (151) generates two composite signals S_{AD} and S_{BC} and further transmits them to the track/hold unit (152), where S_{AD}=S_{A}+S_{D} and S_{BC}=S_{B}+S_{C}. The track/hold unit (152) in this embodiment comprises two track/hold circuits to perform tracking/holding processes over the two composite signals S_{AD} and S_{BC}. The processed composite signals, as the output signals of the signal processing module (130), are denoted with S′_{AD} and S′_{BC}.

In another embodiment, the signal processing module (130) can further comprise a second signal processing unit (153) coupled between the output of the signal processing module (130) and the track/hold unit (152) as shown in FIG. 5B. The second signal processing unit (153) receives the composite signals S′_{AD} and S′_{BC}, and further bases on them to generate a signal S′_{PP}=S′_{AD}−S′_{BC} as the output signals of the signal processing module (130).

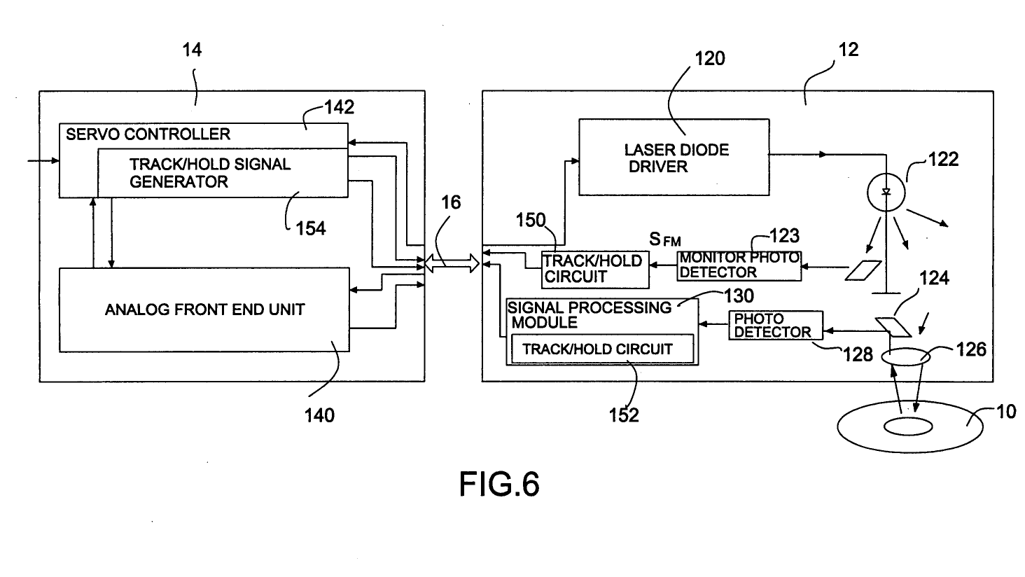

With reference to FIG. 6, the track/hold signal generator (154) is configured in the ODD controller (14), for example in the servo controller (142), rather than in the optical pickup unit (12). The track/hold timing signals output from the track/hold signal generator (154) are delivered to the track/hold circuit (150) and the track/hold unit (152) via the flexible cable (16)

It is noted that the track/hold timing signal for the track/hold circuit (150) are typically different from that for the track/hold unit (152), i.e. the track/hold signal generator (154) supplies two kinds of track/hold timing signals.

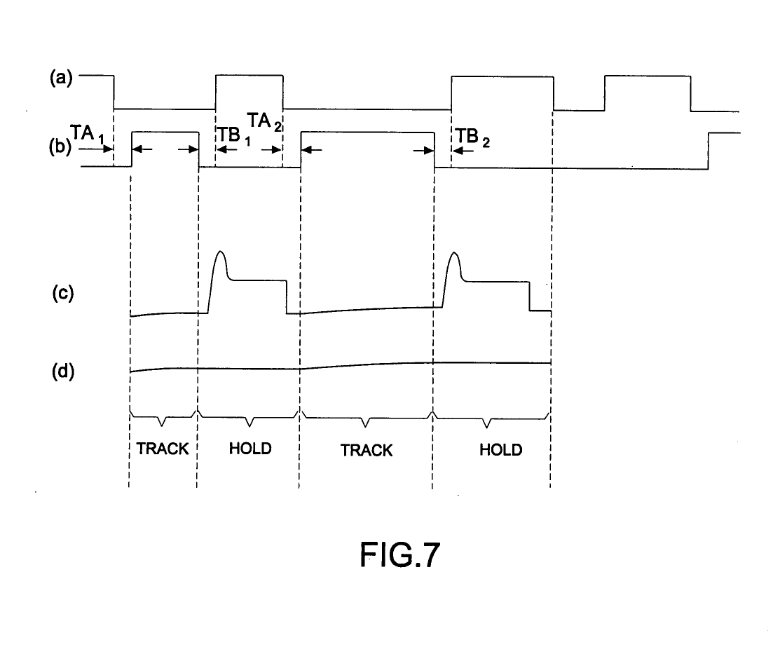

With reference to FIG. 7(a), the EFM signal as a timing reference signal input to the track/hold signal generator (154) is illustrated. Based on the EFM signal, the track/hold signal generator (154) creates a track/hold signal as shown in FIG. 7(b). FIG. 7(c) is a light detection signal intended to be tracked/held. FIG. 7(d) shows the retrieved information from the light detection signal. In this embodiment, the track signal corresponds to the low level of the EFM signal. On the contrary, the hold signal corresponds to the high level of the EFM signal. It is noted that a controllable gap TAi or TBi, i=1, 2, 3 . . . , exists between the rising edge/falling edge of the track/hold signal and the falling edge/rising edge of the EFM signal. The width of the gap TAi or TBi is determined based on the data recording speed or other concerned factors.

As depicted in FIG. 7(c), before being transmitted over the flexible cable, the change between the high/low levels of original light detection signal such as SA is quite apparent. During the “track” periods, the waveform of FIG. 7(d) follows the waveform of the original light detection signal. However, during the “hold” periods, the waveform of FIG. 7(d) is kept at a constant level of a previous tracked signal. From the FIG. 7(d), it is recognized that the tracking process is performed over the desired available portions of the light detection signal and the holding process is applied over the undesired portions. Through those processes, the interference to the desired portions, which is caused from the transmission of flexible cable (16), is able to be effectively mitigated. Furthermore, the track signals may be changed to correspond to the high level of the EFM signal, whereby the waveforms during the pit-forming periods can be retrieved.

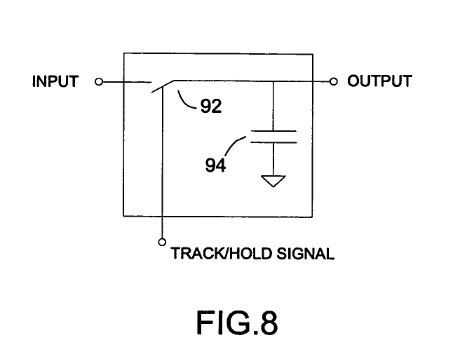

The track/hold circuit can be any a well-known one. For example, FIG. 8 showing an embodiment of a track/hold circuit comprises a switch element (92) and a capacitor (94). The on/off operation of the switch element (92) is controlled by the track/hold signals output from the track/hold signal generator (154). However, other kinds of well-known track/hold circuits are also suitable for use in the present invention.

The above-mentioned track/hold unit (152) comprises at least one track/hold circuit therein. For plural track/hold circuits of the track/hold unit (152), they share the same track/hold signal. The amount of track/hold circuits of the track/hold unit (152) is decided by the function of the signal processing module (130). As an example, if the signal processing module (130) has only the track/hold unit (152) therein to receive the light detection signals output from the photo detector (128), the amount of the track/hold circuits of the track/hold unit (152) is equal to the quantity of the light detection signals.

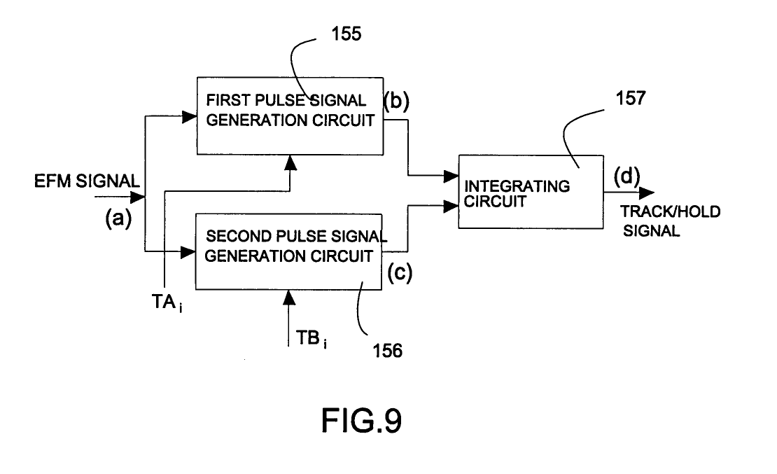

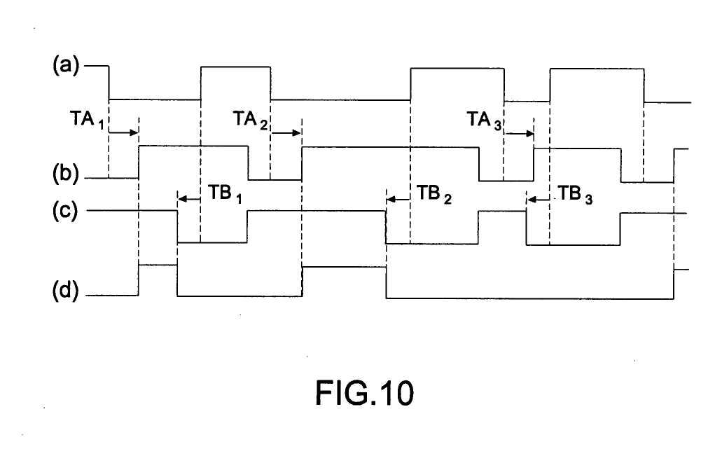

With reference to FIG. 9, an embodiment of a well-known track/hold signal generator (154) comprises a first pulse signal generation circuit (155) and a second pulse signal generation circuit (156). The circuits (155)(156) are based on the EFM signal of FIG. 10A to respectively generate pulse signals of FIGS. 10(b) and 10(c). Parameters TAi and TBi, are applied to the two circuits (155)(156) to adjust widths of their pulse signals. The two pulse signals are then input to an integrating circuit (157) and combined to form a complete track/hold signal through an AND logic gate as shown in FIG. 10(d). It is noted that FIG. 9 is for the purpose of explanation of a track/hold signal generator only, and other types of track/hold signal generators are also suitable for use in the present invention.

Through the foregoing description, the method in accordance with the present invention is to perform a track/hold process over the light detection signals or their composite signals before the light detection signals are transmitted to the ODD controller through the flexible cable (16).

The method may be concluded to comprise the following steps.
receiving a light beam reflected from an optical disk and converting the received light beam into plural light detection signals, wherein the light detection signals can be further calculated to derive composite signals;
performing a track/hold process over an electrical signal based on a track/hold signal, wherein the electrical signal is the plural light detection signals or their composite signals; and
transmitting the tracked/held electrical signal to an optical disk control device through a flexible cable.

Based on the foregoing concept, the method can be further modified as follows:
receiving a light beam reflected from an optical disk and converting the received light beam into plural light detection signals, wherein the light detection signals can be further calculated to derive composite signals;
performing a track/hold process over a first electrical signal based on a track/hold signal, wherein the first electrical signal is the plural light detection signals or their composite signals;
generating a second electrical signal based on the tracked/held first electrical signal;
transmitting the second electrical signal to an optical disk control device through a flexible cable, wherein because the track/hold process had been performed prior to the transmission of the second electrical signal to the optical disk control device via the flexible cable, the distortion of the second electrical signal, caused from the flexible cable, is able to be mitigated and accordingly to ensure its quality.

In conclusion, while the optical disk drive is performing data recording process on a CD/DVD, light detection signals or their composite signals are firstly tracked/held to retrieve more available information before being sent to the ODD controller via the flexible cable. By the signal clamping process, the interference problem, which occurs when the light detection signals are transmitted from the pit-forming period to the land-forming period, is able to be effectively mitigated after these light detection signals or their composite signals are delivered to the ODD controller. The light detection signals have more applicable information during the land-forming period. Furthermore, superior quality of push-pull signals, servo control signals etc. can be derived to enhance the high speed recording process of the optical disk drive.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An optical disk drive system comprising:
an optical pickup unit that has:
a laser light source generating a laser beam to irradiate on a track formed on an optical disk;
a photo detector that receives a reflected light from the optical disk and converts the reflected light signal into plural light detection signals; and
a signal processing module in which the light detection signals are processed to generate at least one electrical signal, wherein the signal processing module comprises a track/hold unit based on a first track/hold signal to perform a track/hold process over signals input to the track/hold unit;
an optical disk drive (ODD) controller provided to control the optical pickup unit; and
at least one flexible cable coupled between the optical disk drive controller and the optical pickup unit for transmitting signals therebetween;
wherein since the track/hold process is performed prior to the at least one electrical signal being transmitted to the ODD controller, a distortion of the at least one electrical signal caused from the flexible cable is mitigated.

2. The optical disk drive system as claimed in claim 1 further comprising a track/hold signal generator that receives a timing reference signal and generates the first track/hold signal based on the received timing reference signal.

3. The optical disk driver system as claimed in claim 2, wherein the timing reference signal is an EFM signal.

4. The optical disk drive system as claimed in claim 2, wherein the track/hold signal generator is configured in the optical pickup unit.

5. The optical disk drive system as claimed in claim 2, wherein the track/hold signal generator is configured in the ODD controller, and the first track/hold signal is transmitted to the track/hold unit through the flexible cable.

6. The optical disk drive system as claimed in claim 1, wherein the track/hold unit in the signal processing module receives and performs the track/hold process over the plural light detection signals, wherein processed results are output signals of the signal processing module.

7. The optical disk drive system as claimed in claim 6, wherein the signal processing module further comprises a first signal processing unit coupled between an input of the signal processing module and the track/hold unit, to process the received plural light detection signals.

8. The optical disk drive system as claimed in claim 6, wherein the signal processing module further comprises a second signal processing unit coupled between an output of the signal processing module and the track/hold unit, to process output signals of the track/hold unit.

9. The optical disk drive system as claimed in claim 1, wherein the signal processing module further comprises:
a first signal processing unit coupled between an input of the signal processing module and the track/hold unit, to process the received plural light detection signals; and
a second signal processing unit coupled between an output of the signal processing module and the track/hold unit, to process output signals of the track/hold unit.

10. The optical disk drive system as claimed in claim 1, wherein the optical pickup unit further comprises:
a monitor photo detector receiving a part of the laser beam and based on the part of the laser beam to generate a monitor signal; and
a track/hold circuit that performs a track/hold process over the monitor signal based on a second track/hold signal, where processed monitor signal is subsequently transmitted to the ODD controller through the flexible cable;
wherein the track/hold signal generator further provides the second track/hold signal to the track/hold circuit.

11. An optical disk drive system comprising:
an optical pickup unit that has:
a laser light source generating a laser beam to irradiate on a track formed on an optical disk;
a monitor light detector receiving a part of the laser beam and based on the part of the laser beam to generate a monitor signal; and
a track/hold circuit that performs a track/hold process over the monitor signal based on a track/hold signal;
an optical disk drive (ODD) controller provided to control the optical pickup unit; and
at least one flexible cable coupled between the optical disk drive controller and the optical pickup unit for transmitting signals therebetween;
wherein since the track/hold process is performed prior to the monitor signal being transmitted to the ODD controller, a distortion of the monitor signal caused from the flexible cable is mitigated.

12. The optical disk drive system as claimed in claim 11 further comprising a track/hold signal generator that receives a timing reference signal and generates the track/hold signal based on the received timing reference signal.

13. The optical disk driver system as claimed in claim 12, wherein the timing reference signal is an EFM signal.

14. The optical disk drive system as claimed in claim 12, wherein the track/hold signal generator is embodied in the optical pickup unit.

15. The optical disk drive system as claimed in claim 12, wherein the track/hold signal generator is embodied in the ODD controller, and the track/hold signal is transmitted to the track/hold circuit through the flexible cable.

16. An optical pickup device having an output terminal coupled to an optical disk drive controller via a flexible cable, the optical pickup device comprising:
a laser light source generating a laser beam to irradiate a track formed on an optical disk;
a photo detector that receives a reflected light from the optical disk and converts the reflected light signal into plural light detection signals;
a track/hold signal generator that receives a timing reference signal and based on it to generate a first track/hold signal; and
a signal processing module in which the light detection signals are processed to become at least one electrical signal, wherein the signal processing module comprises a track/hold unit that based on the first track/hold signal to perform a track/hold process over signals input to the track/hold unit;
wherein since the track/hold process is performed prior to the at least one electrical signal being transmitted to the ODD controller, a distortion of the at least one electrical signal caused from the flexible cable is mitigated.

17. The optical pickup device as claimed in claim 16, wherein the timing reference signal is an EFM signal.

18. The optical pickup device as claimed in claim 16, wherein the track/hold unit receives and performs the track/hold process over the plural light detection signals, wherein processed results are output signals of the signal processing module.

19. The optical pickup device as claimed in claim 18, wherein the signal processing module further comprises a first signal processing unit coupled between an input of the signal processing module and the track/hold unit, to process the received plural light detection signals.

20. The optical pickup device as claimed in claim 18, wherein the signal processing module further comprises a second signal processing unit coupled between an output of the signal processing module and the track/hold unit, to process output signals of the track/hold unit.

21. The optical pickup device as claimed in claim 16, wherein the signal processing module further comprises:
a first signal processing unit coupled between an input of the signal processing module and the track/hold unit, to process the received plural light detection signals; and
a second signal processing unit coupled between an output of the signal processing module and the track/hold unit, to process output signals of the track/hold unit.

22. The optical pickup device as claimed in claim 16, further comprising:
a monitor photo detector receiving a part of the laser beam and based on the part of the laser beam to generate a monitor signal; and
a track/hold circuit that performs a track/hold process over the monitor signal based on a second track/hold signal, where processed monitor signal is subsequently transmitted to the ODD controller through the flexible cable;
wherein the track/hold signal generator further provides the second track/hold signal to the track/hold circuit.

23. An optical pickup device having an output terminal coupled to an optical disk drive controller via a flexible cable, the optical pickup device comprising:
a laser light source generating a laser beam to irradiate a track formed on an optical disk;
a monitor light detector receiving a part of the laser beam and based on the part of the laser beam to generate a monitor signal;
a track/hold signal generator that receives a timing reference signal and based on the timing reference signal to generate a track/hold signal; and
a track/hold circuit that performs a track/hold process over the monitor signal based on the track/hold signal;
wherein since the track/hold process is performed prior to the monitor signal being transmitted to the ODD controller, a distortion of the monitor signal caused from the flexible cable is mitigated.

24. The optical pickup device as claimed in claim 23, wherein the timing reference signal is an EFM signal.

25. A signal processing method of an optical pickup device, the method comprising the acts of:
receiving a light beam reflected from an optical disk and converting the received light beam into plural light detection signals;
performing a track/hold process over at least one electrical signal based on a track/hold signal, wherein the at least one electrical signal is the plural light detection signals or their composite signals; and
transmitting the tracked/held electrical signal to an optical disk control device through a flexible cable;
wherein since the track/hold process is performed prior to the at least one electrical signal being transmitted to the ODD controller, a distortion of the at least one electrical signal caused from the flexible cable is mitigated.

26. A signal processing method of an optical pickup device, the method comprising the acts of:
receiving a light beam reflected from an optical disk and converting the received light beam into plural light detection signals, wherein the light detection signals can be further calculated to derive composite signals;
performing a track/hold process over a first electrical signal based on a track/hold signal, wherein the first electrical signal is the plural light detection signals or their composite signals;
generating a second electrical signal based on the tracked/held first electrical signal;
transmitting the second electrical signal to an optical disk control device through a flexible cable, wherein because the track/hold process had been performed prior to the transmission of the second electrical signal to the optical disk control device via the flexible cable, the distortion of the second electrical signal, caused from the flexible cable, is mitigated.

27. A signal processing method of an optical pickup device, the method comprising the acts of:
receiving a part of a light beam output from a laser diode and converting the received light beam into a monitor signal; and
performing a track/hold process over the monitor signal based on a track/hold signal;
transmitting the tracked/held monitor signal to an optical disk control device through a flexible cable, wherein because the track/hold process had been performed prior to the transmission of the monitor signal to the optical disk control device, the distortion of the monitor signal caused from the flexible cable is mitigated.
